(19) United States
(12) Patent Application Publication
(10) Pub. No.: US 2007/0024925 A1
(43) Pub. Date: Feb. 1, 2007

(54) Light-shielding device for a scanner and scanning method using the device

(75) Inventor: Thomas Sheng, Hsinchu (TW)

Correspondence Address: BIRCH STEWART KOLASCH & BIRCH, PO BOX 747, FALLS CHURCH, VA, 22040-0747, US

(73) Assignee: A VISION INC.

(21) Appl. No.: 11/491,881

(22) Filed: Jul. 25, 2006

(30) Foreign Application Priority Data
Jul. 27, 2005 (TW) 094125346

(51) Int. Cl. H04N 1/04

(52) U.S. Cl. 358/474; 358/475

(57) ABSTRACT

A scanning method using a light-shielding device includes the steps of: providing a light-shielding device; supporting the light-shielding device by a scan platen of a scanner such that the light-shielding device and the scan platen form a window; supporting a reflective original by the scan platen and in the window; and scanning the reflective original.

### BACKGROUND OF THE INVENTION

1. Field of the Invention

The invention relates to a light-shielding device of a scanner and a scanning method using the same, and more particularly to a light-shielding device capable of simplifying the procedures of scanning operations and a scanning method using the light-shielding device.

2. Description of the Related Art

When a user uses a scanner to scan a document, he or she usually lifts an upper cover, then places the document on a scan platen, closes the upper cover, and then enables a scanning module to scan the document. However, the small, thin and light document, such as a receipt, a check, or the like, the downward airflow generated as the upper cover is closed tends to move the document, and the scanned image has a skew. Alternatively, when a lot of documents with the same type are scanned, the user has to open and close the cover repeatedly, thereby making the operation inconvenient and wasting a lot of time.

The commonly assigned Taiwan patent publication No. 234551 discloses a data medium fixing device of an image scanner. The data medium fixing device fixes a transparency such as a film on the scan platen such that the scanning module can scan the transparency. Because the backlight module of the transparency scanner is disposed above the scanning module, the user still has to close the upper cover with the backlight module, and the above-mentioned problem also occurs.

In addition, when the conventional scanner is scanning a book, for example, the upper cover cannot be completely closed onto the glass platen, and the scanned result has a black edge frame. After a print unit prints the scanned result, the black edge frame wastes a lot of consumable material, such as toner or ink. Alternatively, when the book is too thick, the user usually does not close the upper cover, and the user's eyes may see the strong light uncomfortably.

Thus, it is an important subject of the invention to provide a light-shielding device capable of providing an effective light-shielding function and simplifying the procedures of scanning operations, and a scanning method using the light-shielding device.

### SUMMARY OF THE INVENTION

It is therefore an object of the invention to provide a light-shielding device of a scanner and a scanning method using the same in order to make the user fix a document easily and simplify the user's operation procedures. The light-shielding device is adjustable to position various documents with different dimensions.

To achieve the above-mentioned object, the invention provides a scanning method including the steps of: providing a light-shielding device; supporting the light-shielding device by a scan platen of a scanner, wherein the light-shielding device and the scan platen form a window; supporting a reflective original by the scan platen and in the window; and scanning the reflective original.

The invention also provides a light-shielding device adapted to be placed on a scan platen of a scanner. The light-shielding device includes a ring body formed with a window, in which a reflective original is placed, for blocking ambient light, which surrounds the reflective original and is not generated by the scanner. The size of the window is adjustable.

The invention also provides a light-shielding device adapted to be placed on a scan platen of a scanner. The light-shielding device includes an L-shaped body, wherein the L-shaped body and the scan platen form a window, in which a reflective original is placed, for blocking ambient light, which surrounds the reflective original and is not generated by the scanner. The size of the window is also adjustable.

### BRIEF DESCRIPTION OF THE DRAWINGS

FIG. 1 is a pictorially exploded view showing a light-shielding device used in a scanner according to a first embodiment of the invention.

FIG. 2 is a schematically cross-sectional view showing a light-shielding device and a scan platen according to a second embodiment of the invention.

FIG. 3 is a schematically cross-sectional view showing a light-shielding device and a scan platen according to a third embodiment of the invention.

FIG. 4 is a schematic illustration showing a light-shielding device according to a fourth embodiment of the invention.

FIG. 5 is a schematic illustration showing a light-shielding device according to a fifth embodiment of the invention.

FIG. 6 is a schematic illustration showing a light-shielding device according to a sixth embodiment of the invention.

FIG. 7 is a schematic illustration showing a light-shielding device according to a seventh embodiment of the invention.

FIG. 8 is a flow chart showing a scanning method using the light-shielding device according to an eighth embodiment of the invention.

FIG. 9 is a flow chart showing a scanning method using the light-shielding device according to a ninth embodiment of the invention.

### DETAILED DESCRIPTION OF THE INVENTION

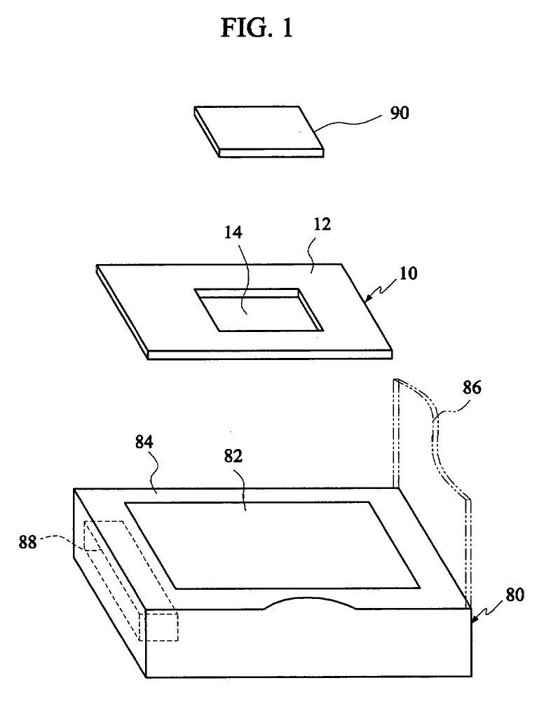

FIG. 1 is a pictorially exploded view showing a light-shielding device 10 used in a scanner according to a first embodiment of the invention. As shown in FIG. 1, the light-shielding device 10 of the invention is to be placed on a scan platen 82 of a scanner 80. The light-shielding device 10 includes a ring body 12 formed with a window 14, in which a reflective original 90 is placed, to block ambient light, which surrounds the reflective original and is not generated by the scanner. The scan platen 82 is usually fixed by an edge frame 84 of the scanner 80. The light-shielding device 10 can rest against the edge frame 84 tightly and thus be positioned. The light-shielding device 10 is made of the opaque material, which is the white material in this embodiment so as to achieve the light-shielding effect and match with the reflective original. The reflective original 90 is placed and thus positioned in the window 14. Thus, the scan result of the scanner 80 after scanning the reflective original 90 has no large side edge, and the light-shielding effect provided by the light-shielding device 10 can prevent the user's eyes from being hurt by the strong light emitted from a scanning module 88.

It is to be noted that the scanner 80 may not have an upper cover. If the scanner does have the cover, the upper cover 86 does not have to be closed when the document is being scanned. Thus, the complexity of operating the scanner can be reduced.

In this embodiment, the window 14 is rectangular to match with the rectangular reflective original 90. However, the window may also have any other shape, such as an elliptic shape, a circular shape, a triangular shape or the like.

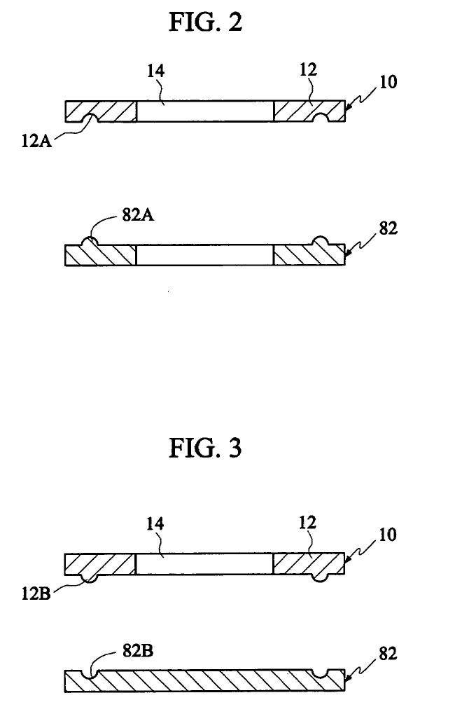

FIG. 2 is a schematically cross-sectional view showing a light-shielding device 10 and a scan platen according to a second embodiment of the invention. Referring to FIG. 2, the ring body 12 of the light-shielding device 10 in this embodiment has a concave portion 12A to be positioned with a convex portion 82A on the scan platen 82.

FIG. 3 is a schematically cross-sectional view showing a light-shielding device 10 and a scan platen according to a third embodiment of the invention. Referring to FIG. 3, the ring body 12 of the light-shielding device 10 in this embodiment has a convex portion 12B to be positioned with a concave portion 82B on the scan platen 82.

The dimension of the window 14 may be fixed. The manufacturer may provide windows 14 with various dimensions such that the users can choose one suitable window 14. However, the window 14 may also have an adjustable dimension.

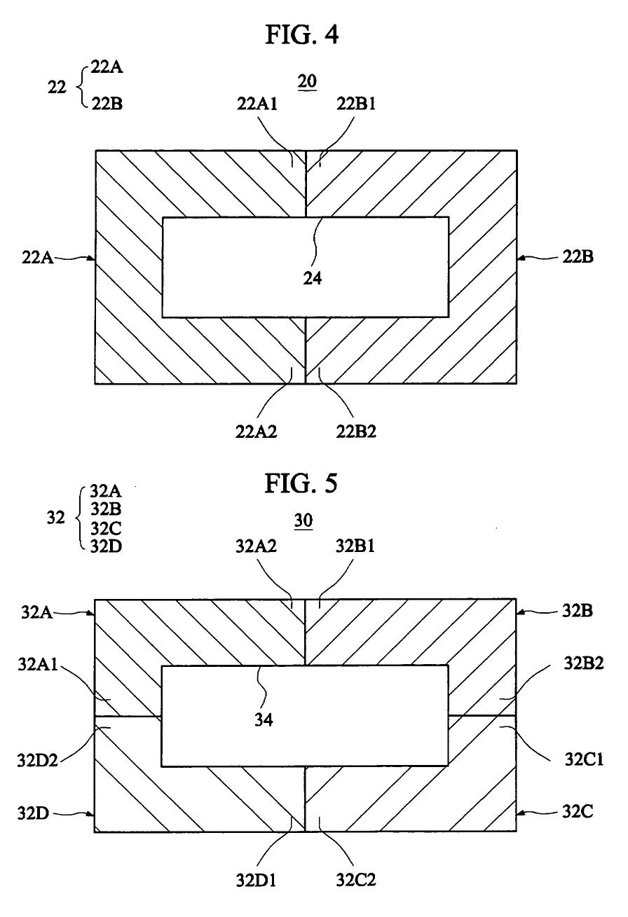

FIG. 4 is a schematic illustration showing a light-shielding device 20 according to a fourth embodiment of the invention. Referring to FIG. 4, a ring body 22 of the light-shielding device 20 in this embodiment includes a first U-shaped portion 22A and a second U-shaped portion 22B. A first end 22B1 of the second U-shaped portion 22B and a first end 22A1 of the first U-shaped portion 22A are coupled to each other and can be retracted relative to each other. The so-called retraction relative to each other means that the first end 22B1 can be retracted into the first end 22A1, or the first end 22A1 can be retracted into the first end 22B1. A second end 22B2 of the second U-shaped portion 22B and a second end 22A2 of the first U-shaped portion 22A are coupled to each other and can be retracted relative to each other such that the dimension of a window 24 can be adjusted.

FIG. 5 is a schematic illustration showing a light-shielding device 30 according to a fifth embodiment of the invention. As shown in FIG. 5, a ring body 32 of the light-shielding device 30 for positioning the document in this embodiment includes a first L-shaped portion 32A, a second L-shaped portion 32B, a third L-shaped portion 32C and a fourth L-shaped portion 32D. A first end 32A1 of the first L-shaped portion 32A and a second end 32D2 of the fourth L-shaped portion 32D are coupled to each other and can be retracted relative to each other. A second end 32A2 of the first L-shaped portion 32A and a first end 32B1 of the second L-shaped portion 32B are coupled to each other and can be retracted relative to each other. A second end 32B2 of the second L-shaped portion 32B and a first end 32C1 of the third L-shaped portion 32C are coupled to each other and can be retracted relative to each other. A second end 32C2 of the third L-shaped portion 32C and a first end 32D1 of the fourth L-shaped portion 32D are coupled to each other and can be retracted relative to each other. Thus, the user can adjust the dimension of a window 34 to match with the reflective originals with different dimensions.

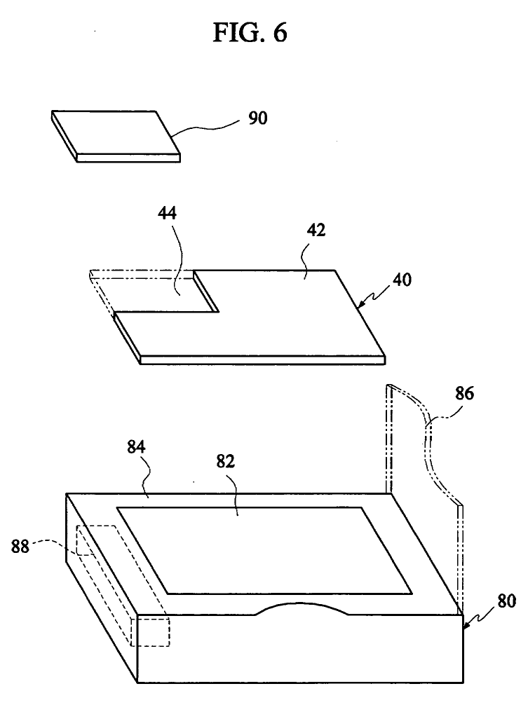

FIG. 6 is a schematic illustration showing a light-shielding device 40 according to a sixth embodiment of the invention. As shown in FIG. 6, the light-shielding device 40 of this embodiment is to be placed on the scan platen 82 of the scanner 80 to position the reflective original 90. The light-shielding device 40 includes an L-shaped body 42. The L-shaped body 42 and the scan platen 82 of the scanner 80 form a window 44, in which the reflective original 90 is placed such that the ambient light, which surrounds the reflective original and is not generated by the scanner, can be blocked.

Similar to FIGS. 2 and 3, the L-shaped body 42 may also have a concave portion to be positioned with the convex portion 82A of the scan platen 82, or a convex portion to be positioned with the concave portion 82B of the scan platen 82.

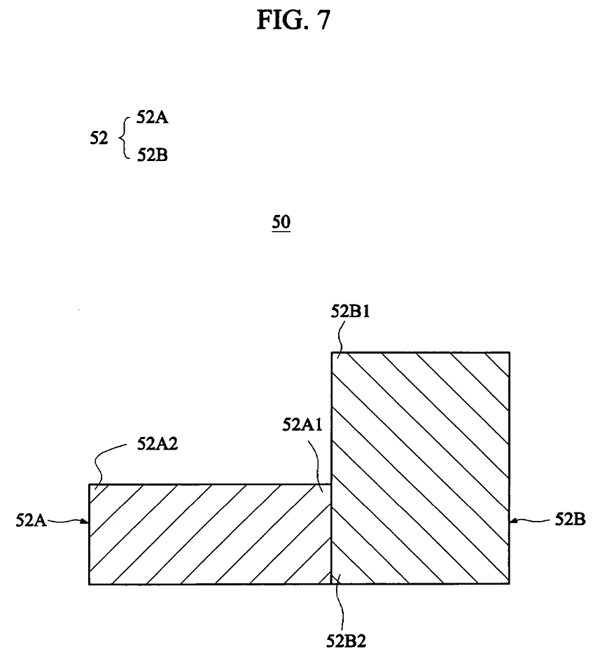

FIG. 7 is a schematic illustration showing a light-shielding device 50 according to a seventh embodiment of the invention. As shown in FIG. 7, an L-shaped body 52 of the light-shielding device 50 includes a first rectangular portion 52A and a second rectangular portion 52B. A first end 52A1 of the first rectangular portion 52A and a second end 52B2 of the second rectangular portion 52B are coupled to each other and can be retracted relative to each other. A second end 52A2 of the first rectangular portion 52A and a first end 52B1 of the second rectangular portion 52B are free ends. Thus, the user can adjust the dimension of the window to match with the reflective originals with different dimensions.

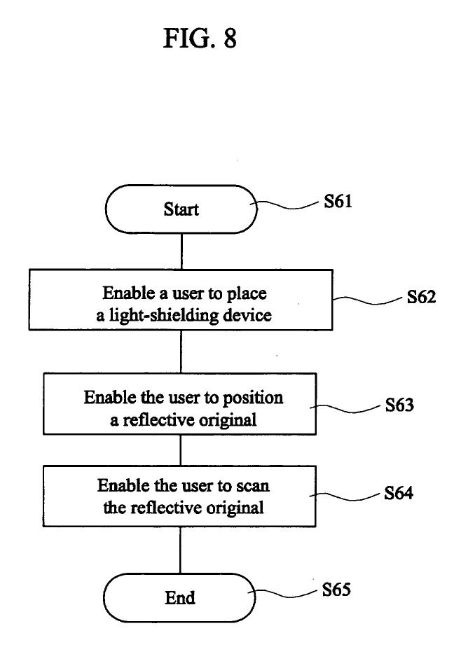

FIG. 8 is a flow chart showing a scanning method using the light-shielding device according to an eighth embodiment of the invention. As shown in FIGS. 8, 1 and 6, the scanning method using the light-shielding device of this embodiment may be recorded in a user manual, an optical disk, an audio tape or a video tape, and the output formats include, without limitation to, voice, texts, pictures, motion pictures and the like. This scanning method includes the following steps. First, the method starts in step S61. Next, the method enables a user to place a light-shielding device 10/40 on a scan platen 82 of a scanner 80, as shown in step S62. The light-shielding device 10/40 and the scanner 80 define a window 14/44, as shown in step S62. Then, the method enables the user to position a reflective original 90 in the window 14/44, as shown in step S63. Next, the method enables the user to enable a scanning module 88 of the scanner 80 to scan the reflective original 90, as shown in step S64. Then, the method ends in step S65.

The steps can be concluded to include the steps of: providing the light-shielding device 10/40; supporting the light-shielding device 10/40 by the scan platen 82 of the scanner 80, wherein the light-shielding device 10/40 and the scan platen 82 form the window 14/44; supporting the reflective original 90 by the scan platen 82 in the window 14/44; and scanning the reflective original 90.

As mentioned hereinabove, the user may enable the scanning module 88 to scan the reflective original 90 when the upper cover 86 of the scanner 80 is not closed. Alternatively, the scanner 80 itself may have no upper cover to be closed onto the scan platen 82. When the dimension of the window 14/44 is adjustable, step S62 may further enable the user to adjust and change the dimension of the window 14/44 to position the reflective original 90.

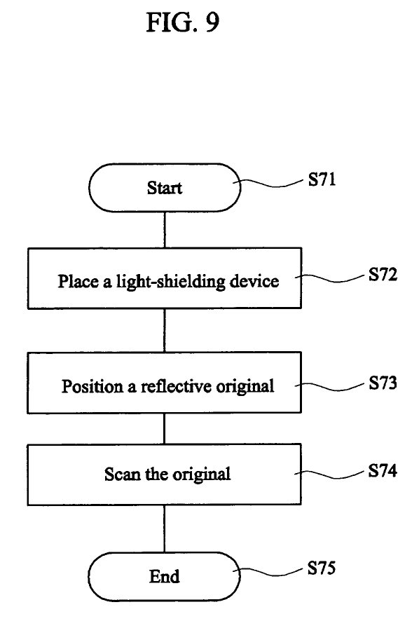

FIG. 9 is a flow chart showing a scanning method using the light-shielding device according to a ninth embodiment of the invention. As shown in FIGS. 9, 1 and 6, the method using the light-shielding device includes the following steps. First, the method starts in step S71. Then, a light-shielding device 10/40 is placed on a scan platen 82 of a scanner 80, as shown in step S72. The light-shielding device 10/40 and the scanner 80 define a window 14/44. Then, a reflective original 90 is positioned in the window 14/44, as shown in step S73. Then, a scanning module 88 of the scanner 80 scans the reflective original 90. Then, the method ends in step S75.

The steps can be concluded to include the steps of: providing the light-shielding device 10/40; supporting the light-shielding device 10/40 by the window 14/44 of the scanner 80, wherein the light-shielding device 10/40 and the scan platen 82 form the window 14/44; supporting the reflective original 90 by the scan platen 82 in the window 14/44; and scanning the reflective original 90.

As mentioned hereinabove, the user may enable the scanning module 88 to scan the reflective original 90 when the upper cover 86 of the scanner 80 is not closed. Alternatively, the scanner 80 itself may have no upper cover to be closed onto the scan platen 82. When the dimension of the window 14/44 is adjustable, step S72 may further enable the user to adjust and change the dimension of the window 14/44 to position the reflective original 90.

According to the device and method of the invention, the user can place the document on the scan platen without opening or closing the upper cover, and then the scanning module of the scanner can scan the document. Consequently, the small, thin and light document, such as a receipt and a check, cannot be moved by the downward airflow generated when the upper cover is closed. Alternatively, the user does not have to open and close the cover when a lot of documents with the same type are scanned. Thus, the user can operate the scanner conveniently without wasting a lot of time. In addition, the light-shielding device may also effectively block the strong light outputted by the optical module so as to protect the user's eyes, and avoid the shading of the large edge frame in the scanned image.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A scanning method, comprising the steps of:
(a) providing a light-shielding device;
(b) supporting the light-shielding device by a scan platen of a scanner, wherein the light-shielding device and the scan platen form a window;
(c) supporting a reflective original by the scan platen and in the window; and
(d) scanning the reflective original.

2. The method according to claim 1, wherein a scanning module is enabled to scan the reflective original when an upper cover of the scanner is not closed.

3. The method according to claim 1, wherein the scanner has no upper cover to be closed onto the scan platen.

4. The method according to claim 1, wherein the step (b) further comprises changing a dimension of the window to position the reflective original.

5. A light-shielding device adapted to be placed on a scan platen of a scanner, the light-shielding device comprising:
a ring body formed with a window, in which a reflective original is placed, for blocking ambient light, which surrounds the reflective original and is not generated by the scanner.

6. The device according to claim 5, wherein the ring body has a concave portion to be positioned with a convex portion on the scan platen.

7. The device according to claim 5, wherein the ring body has a convex portion to be positioned with a concave portion on the scan platen.

8. The device according to claim 5, wherein a dimension of the window is adjustable.

9. The device according to claim 8, wherein the ring body comprises:
a first U-shaped portion; and
a second U-shaped portion, wherein a first end of the second U-shaped portion and a first end of the first U-shaped portion are coupled to each other and can be retracted relative to each other, and a second end of the second U-shaped portion and a second end of the first U-shaped portion are coupled to each other and can be retracted relative to each other in order to adjust the dimension of the window.

10. The device according to claim 8, wherein:
the ring body comprises a first L-shaped portion, a second L-shaped portion, a third L-shaped portion and a fourth L-shaped portion;
a first end of the first L-shaped portion and a second end of the fourth L-shaped portion are coupled to each other and can be retracted relative to each other;
a second end of the first L-shaped portion and a first end of the second L-shaped portion are coupled to each other and can be retracted relative to each other;
a second end of the second L-shaped portion and a first end of the third L-shaped portion are coupled to each other and can be retracted relative to each other, and
a second end of the third L-shaped portion and a first end of the fourth L-shaped portion are coupled to each other and can be retracted relative to each other in order to adjust the dimension of the window.

11. A light-shielding device adapted to be placed on a scan platen of a scanner, the light-shielding device comprising:
an L-shaped body, wherein the L-shaped body and the scan platen form a window, in which a reflective original is placed, for blocking ambient light, which surrounds the reflective original and is not generated by the scanner.

12. The device according to claim 11, wherein the L-shaped body has a concave portion to be positioned with a convex portion on the scan platen.

13. The device according to claim 11, wherein the L-shaped body has a convex portion to be positioned with a concave portion on the scan platen.

14. The device according to claim 11, wherein a dimension of the window is adjustable.

15. The device according to claim 14, wherein the L-shaped body comprises a first rectangular portion and a second rectangular portion, and a first end of the first rectangular portion and a second end of the second rectangular portion are coupled to each other and can be retracted relative to each other in order to adjust the dimension of the window.
